(19) United States
(12) Patent Application Publication
(10) Pub. No.: US 2025/0162070 A1
(43) Pub. Date: May 22, 2025

(54) LIQUID-ASSISTED LASER MICROMACHINING SYSTEMS AND METHODS FOR PROCESSING TRANSPARENT DIELECTRICS AND OPTICAL FIBER COMPONENTS USING SAME

(71) Applicant: CORNING INCORPORATED, CORNING, NY (US)

(72) Inventors: David Francis Dawson-Elli, Charlotte, NC (US); David Mark Lance, Elmira, NY (US); Alranzo Boh Ruffin, Painted Post, NY (US); Alexander Mikhailovich Streltsov, Corning, NY (US)

(21) Appl. No.: 18/946,216

(22) Filed: Nov. 13, 2024

Related U.S. Application Data
(60) Provisional application No. 63/601,532, filed on Nov. 21, 2023.

(51) Int. Cl. B23K 26/067; C03C 23/00; G02B 26/08; G02B 27/12

(52) U.S. Cl. CPC B23K 26/067; C03C 23/0025; G02B 26/0883; G02B 27/126

(57) ABSTRACT

The liquid-assisted micromachining methods include methods of processing a substrate made of a transparent dielectric material. A working surface of the substrate is placed in contact with a liquid-assist medium. A pulsed laser beam is generated and separated into a plurality of beamlets that are formed into a plurality of focus spots that have a fluence to induce multiphoton absorption in the transparent dielectric material. The plurality of focus spots are moved from an initial position in the liquid-assist medium through the substrate and simultaneously moved in one or more directions perpendicular to an optical axis so that each of the plurality of focus spots independently modifies the material along a separate modification path in a continuous volume of the transparent dielectric material. The continuous volume is removed from the substrate to form a feature in the substrate. Optical components formed using the processed substrate are also disclosed.

### CROSS-REFERENCE TO RELATED APPLICATIONS

This application claims the benefit of priority of U.S. Provisional Application Ser. No. 63/601,532, filed on Nov. 21, 2023, the content of which is relied upon and incorporated herein by reference in its entirety.

### FIELD

This disclosure generally pertains to systems and methods for processing transparent dielectrics with a laser, and more particularly pertains to liquid-assisted laser micromachining systems and methods for processing transparent dielectrics and optical fiber components formed using the systems and methods.

### BACKGROUND

Precision machining of materials is needed for many applications. Precision machining allows for the formation of miniature features in materials. Such features include holes, slots, grooves, and chamfers. Traditional techniques for precision machining involve mechanical methods (e.g., cutting, sawing, drilling, and scoring) or chemical methods (e.g., etching).

Adaptation of traditional techniques to more demanding applications, however, has proven to be challenging. There is increasing demand for machining finer features and for forming features in a wider variety of materials. There is currently great interest in the precision machining of hard dielectric materials and in forming high aspect ratio features with a high degree of precision. Computer numerical control (CNC) machining, for example, has challenges in drilling holes with a diameter smaller than 100-200 μm in glass, especially when the aspect ratio (glass thickness to hole diameter) exceeds 10-20.

Laser ablation in air (dry ablation) is an alternative process for machining hard materials and has been demonstrated in a range of glasses and crystals. In dry laser ablation, a high intensity laser is directed to the surface of a material and the energy of the laser is sufficient to break bonds and release matter from the surface. Thermal effects associated with dry laser ablation, however, are disadvantageous for many applications. Thermal effects often lead to surface damage (e.g. oxidation, melting, cracking and stresses) due to residual stress and other effects that limit the resolution of machining. Thermal effects also lead to surface roughness, irregularities or non-uniformities in the dimensions of features formed by dry laser ablation, and to reduced mechanical strength of separated parts due to induced surface flaws. Thermal effects can also limit the ability to form multiple precise features in close proximity to each other, due the radius of affected material around the laser ablation region. Much of the matter released by the laser also remains as debris on the surface. Thus, the accuracy/precision of such a process is limited to 10 to 20 microns at best. The re-deposition of the debris on the walls of the laser-machined features preclude achieving aspect ratios of 10 or more.

Liquid-assisted laser micromachining is an alternative technique designed to overcome the limitations of dry laser ablation. In liquid-assisted laser micromachining, the working surface of the material is placed in contact with a liquid. The presence of the liquid-assist medium increases the rate of heat removal from the material to minimize deleterious thermal effects. This enables multiple precise features to be formed in close proximity to each other. The liquid-assist medium also provides a medium for sweeping away debris formed by the laser and prevents re-deposition of released matter on the surface. Shorter processing times are also possible for liquid-assisted laser micromachining relative to dry laser ablation.

Water is the most common liquid-assist medium used for liquid-assisted laser micromachining. Water has a high thermal conductivity, low viscosity, high surface tension and efficiently removes heat from the surface. The use of water as the liquid-assist medium results in less surface roughness than a dry ablation process.

Some photonic devices utilize an optical fiber inserted into or through a hole in a transparent glass or crystal substrate. Control of the radius of the hole to within a tolerance better than 0.25 μm permits precise positioning of an optical fiber, i.e., to within design and performance specifications. If the RMS (root-means square) roughness of the inside surface of the hole exceeds 0.5 μm, an optical fiber cannot be inserted in the hole without damaging (e.g. scratching or breaking) the fiber. If the hole diameter is increased to avoid damage, the fiber fits loosely in the hole and is susceptible to motion or misalignment in practical applications.

In data centers, optical fiber components in the form of optical guiding devices, optical support members and optical interconnection devices (connectors) and optical interconnection assemblies (connector assemblies) are used to manage optical fibers carried by optical fiber cables, which can carry hundreds or thousands of optical fibers. Handling such large-cross-section, high-stiffness cables with the length of up to 2 km is very difficult, so shorter cable pieces that require splicing are used. Joining such a large number of optical fibers by fusion splicing produces joints with very low optical loss, but it is expensive because of the time required. It is desirable to have less time-consuming process to connect a large number of fibers. Multi-fiber connectors with 12, 16, 24, or 32 single-mode optical fibers are available. Connectors for a higher number of fibers present extreme technical challenges. One such challenge is the need to have a precision optical fiber array in which a large number of optical fibers (e.g. 96) are held in precise positions, with positional errors smaller than 1 micrometer. Another challenge is related to the need of aligning the height of the optical fibers relative to a ferrule end face where submicron accuracies are desired.

### SUMMARY

An aspect (1) of the present disclosure pertains to method of processing a substrate having a substrate body made of a transparent dielectric material and having a first surface and a working surface opposite the first surface, the method comprising: disposing the working surface in contact with a liquid-assist medium; generating a pulsed laser beam; separating the pulsed laser beam into a plurality of beamlets; forming a plurality of focus spots from the plurality of beamlets, wherein each of the focus spots has a fluence above a threshold to induce multiphoton absorption in the transparent dielectric material, wherein the plurality of focus spots each have an initial position in the liquid-assist medium; altering a positioning of the plurality of focus spots in a first direction perpendicular to an optical axis; while the positioning of the plurality of focus spots is altered in the first direction, moving the focus spots relative to the working surface in a second direction parallel to the optical axis so that each of the plurality of focus spots is moved through the substrate toward the first surface, wherein, as each of the plurality of focus spots is moved through the substrate, each focus spot independently modifies the transparent dielectric material along a separate modification path; and removing a continuous volume of the transparent dielectric material containing each of the separate modification paths to form a feature in the substrate.

An aspect (2) of the present disclosure pertains to a method according to the aspect (1), wherein the threshold is 40 J/cm².

An aspect (3) of the present disclosure pertains to a method according to any of the aspects (1)-(2), wherein the pulsed laser beam comprises: a pulse duration that is greater than or equal to 1 picosecond and less than or equal to 50 picoseconds, and a pulse repetition rate that greater than or equal to 1 kHz and less than or equal to 200 kHz.

An aspect (4) of the present disclosure pertains to a method according to any of the aspects (1)-(3), wherein the feature comprises an aspect ratio, calculated as t/d, with t being a depth of the feature measured from the working surface in a direction perpendicular to the working surface and d being an average diameter of the feature measured in a direction perpendicular to that in which the depth is measured, that is greater than or equal to 5.

An aspect (5) of the present disclosure pertains to a method according to the aspect (4), wherein d is less than or equal to 0.5 mm.

An aspect (6) of the present disclosure pertains to a method according to any of the aspects (1)-(5), wherein each of the focus spots comprises a spot size that is greater than or equal to 2 μm and less than or equal to 20 μm.

An aspect (7) of the present disclosure pertains to a method according to any of the aspects (1)-(6), wherein, prior to separating the pulsed laser beam into the plurality of beamlets, the pulsed laser beam comprises an annular power profile.

An aspect (8) of the present disclosure pertains to a method according to any of the aspects (1)-(7), wherein, prior to separating the pulsed laser beam into a plurality of beamlets, the pulsed laser beam is circularly polarized.

An aspect (9) of the present disclosure pertains to a method according to any of the aspects (1)-(8), wherein the separating the pulsed laser beam into the plurality of beamlets comprises transmitting the pulsed laser beam through a beam-splitter, wherein the beam-splitter comprises one of a Wollaston prism, a roof prism, and an inverted pyramid prism.

An aspect (10) of the present disclosure pertains to a method according to the aspect (9), wherein the altering the positioning of the plurality of focus spots in the first direction perpendicular to the optical axis comprises rotating the beam-splitter so that each of the plurality of focus spots rotates around the optical axis in conjunction with one another.

An aspect (11) of the present disclosure pertains to a method according to the aspect (9), wherein the altering the positioning of the plurality of focus spots in the first direction perpendicular to the optical axis comprises independently manipulating a propagation direction of each beamlet using a separate scanning element.

An aspect (12) of the present disclosure pertains to a method according to any of the aspects (1)-(11), wherein forming the plurality of focus spots from the plurality of beamlets comprises transmitting the plurality of beamlets through a focusing lens so as to form the plurality of focus spots in an image plane of the focusing lens.

An aspect (13) of the present disclosure pertains to a method according to the aspect (9), wherein centers of adjacent ones of the plurality of focus spots in the image plane are separated from one another by less than or equal to 0.5 mm.

An aspect (14) of the present disclosure pertains to a method according to the aspect (13), wherein the focus spots do not overlap one another in the image plane.

An aspect (15) of the present disclosure pertains to a method according to any of the aspects (1)-(14), wherein the feature comprises at least one of: a hole, a groove, a channel, a slot and a recess.

An aspect (16) of the present disclosure pertains to a method according to the aspect (15), wherein the feature comprises side walls extending substantially perpendicular to the working surface, the side walls comprising root-mean square (rms) roughness and rms waviness that is less than or equal to 0.5 μm.

An aspect (17) of the present disclosure pertains to a method according to the aspect (15) or the aspect (16), wherein the feature is a substantially cylindrical-shaped hole with a diameter that varies no more than 1% from an average value throughout an entirety of a length thereof.

An aspect (18) of the present disclosure pertains to a method according to any of the aspects (1)-(17), wherein the liquid-assist medium comprises water and optionally includes a surfactant.

An aspect (19) of the present disclosure pertains to a method according to any of the aspects (1)-(18), wherein the substrate comprises glass.

An aspect (20) of the present disclosure pertains to a method of processing a substrate having a substrate body made of a transparent dielectric material and having a first surface and a working surface opposite the first surface, comprising: disposing the working surface in contact with a liquid-assist medium; generating a pulsed laser beam, separating the pulsed laser beam into a plurality of beamlets and transmitting the plurality of beamlets through a focusing lens to form a plurality of non-overlapping focus spots in an image plane of the focusing lens located initially in the liquid-assist medium; moving the plurality of non-overlapping focus spots in the image plane relative to an optical axis of the focusing lens; while the non-overlapping focus spots are moved in the image plane, moving the image plane relative to the working surface along the optical axis so that each of the plurality of non-overlapping focus spots is moved through the substrate toward the first surface such that each focus spot independently modifies the transparent dielectric material along a modification path; and removing a continuous volume of the transparent dielectric material containing each of the modification paths to form a feature in the substrate.

An aspect (21) of the present disclosure pertains to a method according to the aspect (20), wherein each of the plurality of non-overlapping focus spots independently induces a non-linear absorption in the substrate to modify the transparent dielectric material.

An aspect (22) of the present disclosure pertains to a method according to any of the aspects (20)-(21), wherein the pulsed laser beam comprises: a pulse duration that is greater than or equal to 1 picosecond and less than or equal to 50 picoseconds, and a pulse repetition rate that greater than or equal to 1 kHz and less than or equal to 200 kHz.

An aspect (23) of the present disclosure pertains to a method according to any of the aspects (20)-(22), wherein the feature comprises an aspect ratio, calculated as t/d, with t being a depth of the feature measured from the working surface in a direction perpendicular to the working surface and d being an average diameter of the feature measured in a direction perpendicular to that in which the depth is measured, that is greater than or equal to 5.

An aspect (24) of the present disclosure pertains to a method according to the aspect (23), wherein d is less than or equal to 0.5 mm.

An aspect (25) of the present disclosure pertains to a method according to any of the aspects (20)-(24), wherein each of the non-overlapping focus spots comprises a spot size that is greater than or equal to 2 μm and less than or equal to 20 μm.

An aspect (26) of the present disclosure pertains to a method according to any of the aspects (20)-(25), wherein, prior to separating the pulsed laser beam into a plurality of beamlets, the pulsed laser beam comprises an annular power profile.

An aspect (27) of the present disclosure pertains to a method according to any of the aspects (20)-(26), wherein, prior to separating the pulsed laser beam into a plurality of beamlets, the pulsed laser beam is circularly polarized.

An aspect (28) of the present disclosure pertains to a method according to any of the aspects (20)-(27), wherein the separating the pulsed laser beam into the plurality of beamlets comprises transmitting the pulsed laser beam through a beam-splitter, wherein the beam-splitter comprises one of a Wollaston prism, a roof prism, and an inverted pyramid prism.

An aspect (29) of the present disclosure pertains to a method according to the aspect (28), wherein the moving the plurality of focus spots in the image plane comprises rotating the beam-splitter so that each of the plurality of focus spots rotates around the optical axis in conjunction with one another.

An aspect (30) of the present disclosure pertains to a method according to the aspect (28), wherein the moving the plurality of focus spots in the image plane comprises independently manipulating a propagation direction of each beamlet using a separate scanning element.

An aspect (31) of the present disclosure pertains to a method according to any of the aspects (20)-(30), wherein centers of adjacent ones of are separated from one another by less than or equal to 0.5 mm in the image plane.

An aspect (32) of the present disclosure pertains to a method according to any of the aspects (20)-(31), wherein the feature comprises at least one of: a hole, a groove, a channel, a slot and a recess.

An aspect (33) of the present disclosure pertains to a method according to the aspect (32), wherein the feature comprises side walls extending substantially perpendicular to the working surface, the side walls comprising root-mean square (rms) roughness and rms waviness that is less than or equal to 0.5 μm.

An aspect (34) of the present disclosure pertains to a method according to any of the aspects (32)-(33), wherein at least a portion of the feature is a substantially cylindrical-shaped hole with a diameter that varies no more than 1% from an average value throughout an entirety of a length thereof.

An aspect (35) of the present disclosure pertains to a method according to the aspect (34), further comprising inserting an optical fiber, or a core portion thereof, into the hole so that the optical fiber extends through the hole.

An aspect (36) of the present disclosure pertains to a method according to any of the aspects (20)-(35), wherein the liquid-assist medium comprises water.

An aspect (37) of the present disclosure pertains to a method according to any of the aspects (20)-(36), wherein the substrate comprises glass.

An aspect (38) of the present disclosure pertains to a system for processing a substrate formed of a transparent dielectric material: a cuvette configured to contain a liquid-assist medium, the cuvette containing one or more openings so that the liquid assist medium can contact a working surface of the substrate when the substrate is positioned adjacent to the cuvette; a pulsed laser beam source configured to emit a pulsed laser beam; an optical system comprising: a beam-splitter configured to separate the pulsed laser beam into a plurality of beamlets; and focusing optics configured to generate a plurality of focus spots from the plurality of beamlets, wherein the optical system is configured to manipulate a propagation direction of the plurality of beamlets so that the beamlets move in an image plane of the focusing optics such that the plurality of focus spots do not overlap in the image plane; and a movement means configured to alter the position of the image plane such that the plurality of focus spots move along an optical axis of the system from a first position in the liquid-assist medium to a second position within the substrate when the substrate is positioned adjacent to the cuvette in contact with the liquid-assist medium.

An aspect (39) of the present disclosure pertains to a system according to the aspect (38), wherein the pulsed laser beam comprises: a pulse duration that is greater than or equal to 1 picosecond and less than or equal to 50 picoseconds, and a pulse repetition rate that greater than or equal to 1 kHz and less than or equal to 200 kHz.

An aspect (40) of the present disclosure pertains to a system according to any of the aspects (38)-(39), further comprising beam shaping optics configured to shape a power profile of the pulsed laser beam into an annular profile.

An aspect (41) of the present disclosure pertains to a system according to any of the aspects (38)-(40), wherein the beam-splitter comprises one of a Wollaston prism, a roof prism, and an inverted pyramid prism.

An aspect (42) of the present disclosure pertains to a system according to any of the aspects (38)-(41), wherein the optical system is configured to manipulate the propagation direction of the plurality of beamlets via an actuator configured to rotate the beam-splitter such that the plurality of focus spots rotate around the optical axis in the image plane.

An aspect (43) of the present disclosure pertains to a system according to any of the aspects (38)-(41), wherein the optical system is configured to manipulate the propagation direction of the plurality of beamlets via a plurality of scanning elements configured to independently manipulate the propagation direction of an individual one of the plurality of beamlets.

An aspect (44) of the present disclosure pertains to a system according to any of the aspects (38)-(43), wherein each of the plurality focus spots comprises a spot size that is greater than or equal to 2 μm and less than or equal to 20 μm, wherein the plurality of focus spots move in the image plane such that centers of adjacent ones of the plurality of focus spots are separated from one another by no more than 0.5 mm in the image plane.

An aspect (45) of the present disclosure pertains to a system according to any of the aspects (38)-(44), wherein the movement means comprises a translation stage upon which the cuvette is disposed, wherein the translation stage is configured to move the cuvette along the optical axis as the plurality of focus spots move in the image plane.

Additional features and advantages will be set forth in the detailed description which follows, and in part will be apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1A is a schematic elevated view of an example liquid-assisted laser-based micromachining system for processing a transparent dielectric to form an optical interconnection devices, according to one or more embodiments of the present disclosure;

FIG. 1B is a side view of the liquid-assisted laser-based micromachining system of FIG. 1A, according to one or more embodiments of the present disclosure;

FIG. 2A is a close-up view of the substrate and the cuvette showing an initial focus position of a plurality focus spots within a liquid-assist medium and adjacent the interface between the liquid-assist medium and a working surface of the substrate; according to one or more embodiments of the present disclosure;

FIG. 2B shows modifications paths of the plurality of focal spots where the material that constitutes the body of the substrate is modified as part of the process of forming a feature in the substrate, according to one or more embodiments of the present disclosure;

FIG. 2C shows the modification paths when completed in an example where the modification paths extend from the working surface to another surface of the substrate, with the close-up insets showing example micromachined regions that constitute the modification, according to one or more embodiments of the present disclosure;

FIG. 2D is shows the removal of a continuous volume of dielectric material containing each modification path that is removed to define a feature in the substrate in the form of a through hole, according to one or more embodiments of the present disclosure;

FIG. 3A schematically depicts a perspective view of an optical system for splitting a pulsed laser beam into a plurality of beamlets, generating a plurality of focal spots, and moving the plurality of focal spots in a direction perpendicular to an optical axis in conjunction with one another, according to one or more embodiments of the present disclosure;

FIG. 3B schematically depicts a perspective view of an optical system for splitting a pulsed laser beam into a plurality of beamlets, generating a plurality of focal spots, and independently moving the plurality of focal spots in a direction perpendicular to an optical axis, according to one or more embodiments of the present disclosure;

FIG. 3C schematically depicts a beam-splitter and focusing optics of a system determining a separation of focal spots, according to one or more embodiments of the present disclosure;

FIG. 4A schematically depicts an annular power profile for a pulsed laser beam, according to one or more embodiments of the present disclosure;

FIG. 4B is a plot of power as a function of radial position in the power profile depicted in FIG. 4A, according to one or more embodiments of the present disclosure;

FIG. 5A is a back elevated view of an example guide member that includes an array of features in the form of three fiber through-holes arranged in a row along the x-direction, according to one or more embodiments of the present disclosure;

FIG. 5B shows an example optical fiber guiding device (“guiding device”) that comprises the guide member of FIG. 5A and an array of three optical fibers that respectively extend through the three fiber through-holes, according to one or more embodiments of the present disclosure;

FIG. 6A is a back elevated view of an example interconnect member that includes an array of features in the form of three fiber through-holes arranged in a row along the x-direction, according to one or more embodiments of the present disclosure;

FIG. 6B is close-up y-z cross-sectional view of an example fiber through-hole the interconnection member shown in FIG. 6A, wherein the fiber through-hole has three regions configured to facilitate optical coupling between two optical fibers, according to one or more embodiments of the present disclosure;

FIG. 6C shows two optical fibers interfaced (end coupled) within the fiber through-hole of the interconnection member shown in FIGS. 6A-6B, with the fiber end faces confronting or in contact within the central region of the fiber through-hole, according to one or more embodiments of the present disclosure; and

FIG. 6D is a back elevated view of an example optical fiber interconnection device (“interconnection device”) that comprises the interconnection member of FIG. 6A and three pairs of optical fibers, according to one or more embodiments of the present disclosure.

The embodiments set forth in the drawings are illustrative in nature and not intended to be limiting of the scope of the detailed description or claims. Whenever possible, the same reference numeral will be used throughout the drawings to refer to the same or like feature. The drawings are not necessarily to scale for ease of illustration an explanation.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

### Definitions and Explanation of Select Terms

The following definitions and explanations regarding certain terms apply to the specification and claims that follow.

“Include,” “includes,” or like terms means encompassing but not limited to, that is, inclusive and not exclusive.

The term “consists of” or “consisting of” and like terms are understood as being a special case of the more general term “comprising” or “comprises,” so that the expression “A comprises B” and like expressions also includes “A consists of B” and like terms as a special case.

The terms “downstream” and “upstream” are used to describe positions of objects relative to a direction of light travel, so that A upstream (downstream) of B means that light is incident upon A before (after) B.

The indefinite article “a” or “an” and its corresponding definite article “the” as used herein means at least one, or one or more, unless specified otherwise.

As used herein, the aspect ratio of a feature refers to the ratio of a linear dimension of the feature normal to the incident surface to the smallest linear dimension of the feature orthogonal to the linear dimension of the feature normal to the incident surface.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening elements. Elements in contact may be rigidly or non-rigidly joined. Contacting refers to placing two elements in direct or indirect contact. Elements in direct (indirect) contact may be said to directly (indirectly) contact each other.

As used herein, a material is “transparent” to a wavelength of light if the internal transmission of light at the wavelength is greater than 80%. Preferably, the internal transmission is greater than 90%, or greater than 95%. As used herein, internal transmission refers to transmission exclusive of reflection losses.

As used herein, “working surface” refers to a surface of a substrate in contact with a liquid-assist medium in a liquid-assisted laser micromachining process.

An “optical fiber component” is any element or assembly that is used to operably support at least one optical fiber. Example optical fiber components include optical fiber guide members, optical fiber support members and optical fiber interconnection devices.

Cartesian coordinates are used in some of the Figures for reference and ease of explanation and are not intended to be limiting as to direction and/or orientation.

The abbreviation μm is short for micron or micrometer, which is 10-6 meter. The abbreviation μm and the term micron are used interchangeably herein.

The claims as set forth below are incorporated into and constitute part of this Detailed Description.

### Liquid-Assisted Laser-Based Micromachining System

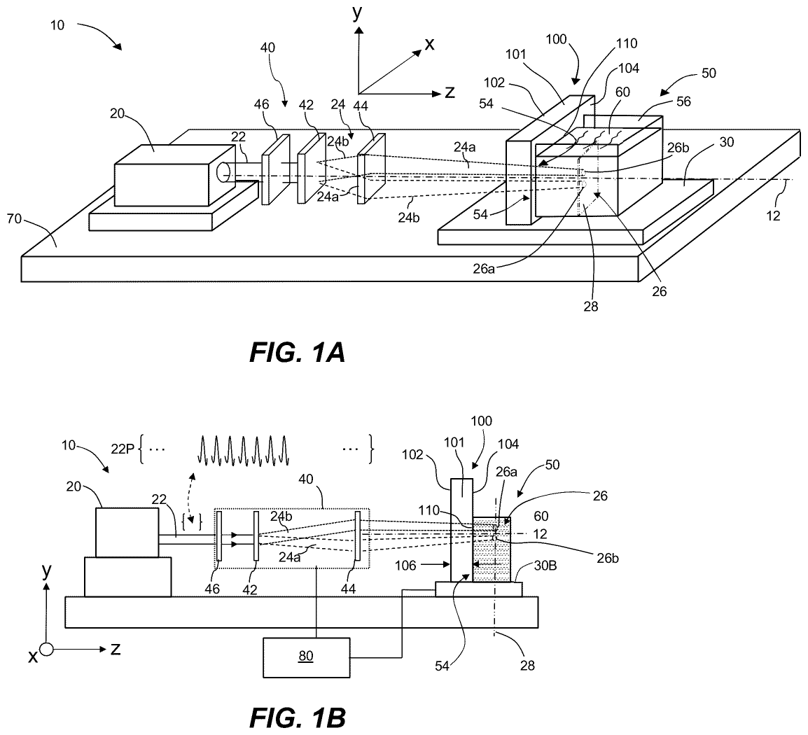

FIG. 1A is a schematic elevated view of an example liquid-assisted laser-based micromachining system (“system”) 10 for processing a transparent dielectric as disclosed herein. FIG. 1B is a schematic side view of the system of FIG. 1A. The system 10 includes a pulsed laser beam source 20, which produces a pulsed laser beam 22 that passes in a direction of propagation. In embodiments, the direction of propagation is along an optical axis 12 of the system 10. In an example, the pulsed laser beam source 20 can include beam collimating optics (not shown) such that pulsed laser beam 22 is collimated upon emission from the pulsed laser beam source 20. The wavelength of the pulsed laser beam source 20 can be any wavelength at which the dielectric material of the substrate 100 is transparent. Typical laser wavelengths for common substrates are in the UV, visible, or infrared portions of the electromagnetic spectrum. Representative laser wavelengths include wavelengths in the range from 325 nm-1700 nm, or in the range from 400 nm-1500 nm, or in the range from 500 nm-1250 nm, or in the range from 700 nm-1100 nm.

As shown in FIG. 1B, the pulsed laser beam 22 comprises a train of laser pulses 22P. The duration of the laser pulses 22P can vary over a range extending from the femtosecond (fs) regime to the picosecond (ps) regime to the nanosecond (ns) regime. Representative pulse durations are in the range from 1 fs-100 ns, or in the range from 5 fs-10 ns, or in the range from 10 fs-1 ns, or in the range from 100 fs-100 ps, or in the range from 1 ps-10 ps. In some aspects, shorter laser pulses 22P are preferable to longer laser pulses. While not wishing to be bound by theory, it is believed that surface roughness is higher when longer laser pulses 22P are used because longer laser pulses have higher threshold pulse energies for ablation and lead to ablation of larger pieces of matter than shorter laser pulses. On the other hand, longer laser pulses 22P allow for higher material removal rate. Based on these considerations, picosecond laser pulses provide a good combination of low surface roughness and high material removal rates. Accordingly, in embodiments, the laser beam parameters comprise a pulse length for the laser pulses 22P in the range from 1 to 50 ps. In such embodiments, the laser pulses 22P can comprise laser pulse energies in the range from 10 μJ to 100 μJ and a repetition rate in the range from 1 kHz to 1 MHz or in the range from 1 kHz to 500 kHz, or even more preferably from 5 kHz to 200 kHz. Moreover, such pulses having the previously described pulse length, repetition rate, and energies can comprise: a wavelength (or spectral width) in the range from 300 nm to 2 μm (e.g., 355 nm, 532 nm, 1064 nm, or other suitable wavelength); and a laser beam (or cuvette) translation speed in the range from 0.1 mm/s to 10 mm/s. The pulsed laser beam 22 can also have a variety of cross-sectional power profiles (e.g., Gaussian, annular, vortex, Bessel), though, as described herein, annular power profiles may be preferably used when relatively small features (e.g., having diameters less than 250 μm or less than 100 μm) are being formed.

The operating parameters for the pulsed laser beam 22 mentioned in the preceding paragraph are selected so that the pulsed laser beam 22, after being separated into a plurality of beamlets 24 as described in greater detail herein, each beamlet is capable of inducing multiphoton absorption in transparent dielectric material of a substrate 100. Different materials have different threshold fluences that are required to induce multiphoton absorption. Rather than creating damage lines by heating the dielectric material, nonlinear absorption creates damage lines by breaking molecular bonds, resulting in smoother, more controlled features. When the substrate 100 is formed of glass, the threshold fluence may be approximately 40 J/cm². Optics of the system 10 described herein (e.g., the optical system 40 described herein) may be selected so as to achieve a suitable spot size for providing the threshold fluence at the plurality of focus spots 26 described herein. The power of the pulsed laser beam 22 needed depends on the number of beamlets generated by the system 10 (e.g., a system configured to generate 4 beamlets will need twice as much power as a system configured to generate 2 beamlets, holding everything else constant). In embodiments, the pulsed laser beam source 20 is configured such that the pulsed laser beam 22 exhibits a power in a range from 1 W to 10 W (e.g., from 1 W to 5 W).

Referring still to FIGS. 1A and 1B, the system 10 further includes an optical system 40. The optical system 40 can comprise various components configured to modify the pulsed laser beam 22 for processing the substrate 100. In the depicted embodiment, the optical system 40 includes a beam-splitter 42, focusing optics 44, and conditioning optics 46. The beam-splitter 42 is generally configured to convert the pulsed laser beam 22 into a plurality of beamlets 24. The structure of the beam-splitter 42 is not particularly limiting and may be selected based on desired attributes of the plurality of beamlets 24. While the beam-splitter 42 is depicted to operate in transmission mode, it should be understood that reflective beam-splitters may also be used. In embodiments, a suitable diffractive optical element (e.g., a diffractive beam splitter, a spatial light modulator or metasurface) can be used as the beam-splitter 42. In embodiments, the beam-splitter 42 operates to separate the pulsed laser beam 22 into beamlets having different polarizations (e.g., a Wollaston prism or the like). In embodiments, the beam-splitter 42 comprises a dispersive optical element configured to separate the pulsed laser beam 22 into the plurality of beamlets 24 (e.g., a roof prism, an inverted pyramid prism). The particular structure of the beam-splitter 42 may be chosen based on the power and other characteristics of the pulsed laser beam 22 (e.g., polarization, wavelength, power profile), the number of beamlets desired in processing the substrate 100 to form features therein, and the shape of the features to be formed in the substrate 100 via movement of the plurality of beamlets 24 via the methods described herein. Further details of example optical elements that may be used as the beam-splitter 42 are provided herein.

The beam-splitter 42 may be used to generate any suitable number of beamlets for processing the substrate 100. In embodiments, the plurality of beamlets 24 can include 2 beamlets, 4 beamlets, 6 beamlets, 8 beamlets (even or odd number of beamlets), or an even greater number of beamlets, provided that each beamlet has a threshold fluence to independently modify the material of the substrate 100, as described herein. In the depicted embodiments, the beam-splitter 42 separates the pulsed laser beam 22 into a first beamlet 24a and a second beamlet 24b (e.g., the beam-splitter 42 may be a wedge prism or Wollaston prism). As described herein, the beam-splitter 42 may be configured such that the first and second beamlets 24a, 24b generally retain the properties (e.g., pulse duration, spectral width, beam size) of the pulsed laser beam 22.

The focusing optics 44 are generally configured to focus the plurality of beamlets 24 into a plurality of focus spots 26. For example, in embodiments, the focusing optics 44 comprising a focusing lens (e.g., a suitable singlet or doublet lens) having an image plane 28. The focusing lens can be disposed to focus each of the plurality of beamlets 24 in the image plane 28. For example, the focusing lens can be constructed and arranged so that the first beamlet 24a is focused to generate a first focus spot 26a at a first position in the image plane 28 and the second beamlet 24b is focused to generate a second focus spot 26b at a second position in the image plane 28. The first and second focus spots 26a, 26b can have any suitable arrangement in the image plane 28. For example, in the depicted embodiment, the first and second focus spots 26a, 26b are symmetrically arranged about the optical axis 12 and the image plane 28 extends perpendicular to the optical axis 12 (e.g., in the x-y plane). Such a configuration maximizes separation of the first and second focus spots 26a, 26b in the image plane 28 while focusing the first and second beamlets 24a, 24b to a small enough spot size to provide fluences over the threshold for inducing multiphoton absorption in the substrate 100, as described herein. Other arrangements for the focusing optics are also contemplated. For example, in embodiments, the image plane 28 may not extend perpendicular to the optical axis 12 so that the plurality of focus spots 26 are formed at different positions along the optical axis 12. In embodiments, separate optical elements can be used to individually focus the plurality of beamlets 24. Moreover, the focusing optics 44 and beam-splitter 42 may be constructed and arranged so that the plurality of focus spots 26 have different sizes, shapes, and/or are non-uniformly distributed (including focusing in different image planes).

In embodiments, the focusing optics 44 are configured such that the plurality of focus spots 26 have a focal spot size (diameter for gaussian beam, minor axis for elliptical beam profile) that is greater than or equal to 2 μm and less than or equal to 20 μm or preferably greater than or equal to 2 μm and less than or equal to 10 μm. It has been found that such a focal spot size range is suitable when pulsed laser beams generated by commercially available laser sources provide suitable fluences to induce multiphoton absorption in glass substrates when the pulsed laser beams are separated into two or four beamlets. Other focus spot sizes may be used to modify other dielectric materials for the substrate 100 via the methods described herein.

The optical system 40 can further include conditioning optics 46. The conditioning optics 46 may be configured to shape the pulsed laser beam 22 and perform various additional operations (e.g., polarization, spectral filtering, collimation, beam size adjustment) thereto. In embodiments, for example, the conditioning optics 46 include a quarter waveplate aligned to circularly polarize the pulsed laser beam 22 prior to incidence on the beam-splitter 42. As described in greater detail herein, certain embodiments may rely on rotation of the beam-splitter 42 to manipulate the propagation direction of the plurality of beamlets 24 and establish a movement pattern for the plurality of focus spots 26 in one or more directions perpendicular to the optical axis 12. Circular polarization of the pulsed laser beam may eliminate the beamlet's power dependence on the rotation angle of the beam-splitter 42 and enable consistent modification of the substrate 100 when rotating the beam-splitter 42.

In embodiments, the conditioning optics 46 can further include beam shaping optics. The beam shaping optics may include any number of optical elements configured to manipulate the cross-sectional power profile of the pulsed laser beam. In embodiments, the beam shaping optics are configured to impart a non-uniform phase to the pulsed laser beam 22 such that, after transmittal through the beam shaping optics, the pulsed laser beam 22 has an annular power profile. For example, the beam shaping optics may include an axicon and optical elements, as described in U.S. Pre-Grant Publication No. 2019/0062196 A1, entitled “Apparatuses and Methods for Laser Processing Transparent Workpieces Using an Afocal Beam Adjustment Assembly,” hereby incorporated by reference in its entirety, to generate such an annular beam profile. It is believed that providing an annular beam profile upstream of the beam-splitter 42 facilitates tighter focusing of the plurality of focus spots 26 and micromachining with a higher degree of precision.

Referring still to FIGS. 1A and 1B, the system 10 also includes a cuvette 50 having an interior 56 configured to contain a liquid-assist medium 60, which in an example comprises water or consists essentially of water (and optionally including a surfactant). Any suitable liquid assist medium, such as those described in U.S. Pat. No. 11,247,932 B2, entitled “Liquid-Assisted Laser Micromachining Systems and Methods for Processing Transparent Dielectrics and Optical Fiber Components Using the Same,” hereby incorporated by reference in its entirety, may also be used. In an example, the cuvette 50 is operably supported by a movable precision x-y-z stage 30 that can move the cuvette in one or more of the x, y and z directions in precise increments. In an example, the system 10 only includes the movable precision x-y-z stage 30 and the laser source is substantially stationary (e.g., is movable for coarse alignment). In an example, the pulsed laser beam source 20, the optical system 40, and the cuvette 50 are operably supported by a support base 70 such as an optical bench or like stable platform. As shown in FIG. 1B, a computer controller 80 may operably connected to the movable precision x-y-z stage 30 and the optical system 40 to control the movement of various components of the system 10 to carry out the micromachining methods described herein. The cuvette 50 has an open side 54 whose purpose is described below.

The system 10 is configured to process the substrate 100, which, as shown, includes a body 101 that defines a first surface 102 and a back surface 104. In embodiments, the substrate 100 is formed of a transparent dielectric material, and in examples comprises a glass material, a glass-ceramic material or a crystalline material. In an example, the transparent dielectric substrate comprises sapphire. Example glasses include oxide glasses and non-oxide glasses. Preferred glasses are silica glasses, including alkali silica glasses and alkaline earth silica glasses. Glasses include glasses strengthened by ion exchange or thermal tempering. Example crystals include oxide crystals, such as metal oxides, and non-oxide crystals. Example glasses can include soda-lime glasses, alkaline earth boro-aluminosilicate glasses, alkali-aluminosilicate glasses, and Corning Iris™ glass.

In an example, the transparent dielectric substrate (hereinafter, “substrate”) 100 is rectangular and substantially planar with substantially parallel front and back surfaces 102 and 104 such that the thickness 106 is substantially constant. Other shapes for the substrate 100 can also be employed, and the rectangular and planar substrate is shown by way of example and for case of illustration and explanation. In an example, the thickness 106 of the substrate 100 in the z-direction is at least 0.1 mm or at least 0.2 mm or at least 0.5 mm. The substrate 100 is disposed in system 10 so that the back surface 104 is in direct contact with the liquid-assist medium 60 of the cuvette 50 at the open side 54. In an example, the substrate 100 is also supported by the movable precision x-y-z stage 30 so that the substrate and cuvette 50 move together.

In the operation of the system 10 to carry out the micromachining methods disclosed herein, the substrate 100 is moved into a desired position relative to the optical axis 12 using the movable precision x-y-z stage 30. Once in position, the pulsed laser beam source 20 is activated such that the pulsed laser beam 22 is substantially collimated, which is received by the optical system 40. As described herein, the optical system 40 forms a plurality of focus spots 26 from the pulsed laser beam 22 by first separating the pulsed laser beam in the plurality of beamlets 24 via the beam-splitter 42 and then focusing the plurality of beamlets 24 via the focusing optics 44. The plurality of focus spots 26 may each be formed at a position along the optical axis 12 in which each of the plurality of beamlets 24 has a minimum spot size (e.g., a diameter defined by a Gaussian beam waist). Each of the plurality of focus spots 26 can also have associated Rayleigh length, which in an example is in the rage from 1.6 microns to 20 microns. An exemplary focus spot diameter is 2 microns and an exemplary Rayleigh length is 6.5 microns for applications where the substrate 100 has the form of a thin sheet of glass.

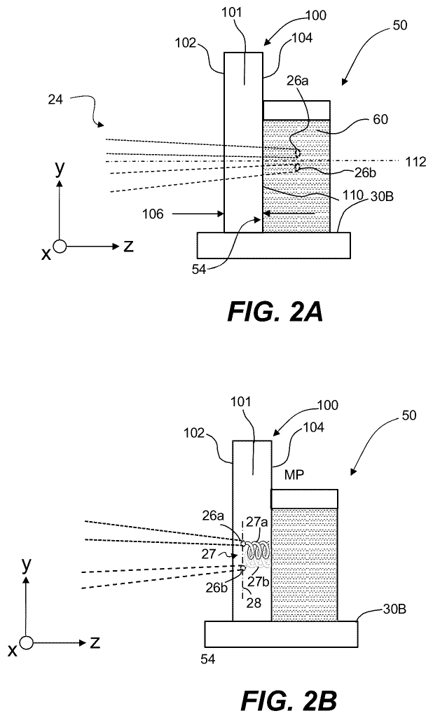

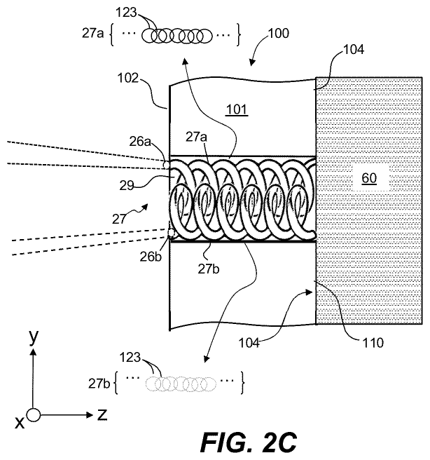

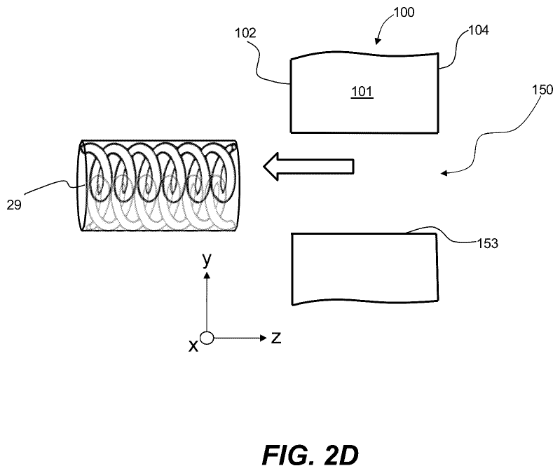

In an example, each of the plurality of beamlets 24 initially passes through the substrate 100 and forms one of the plurality of focus spots 26 within the liquid-assist medium 60. FIG. 2A is a close-up view of the substrate 100 and the cuvette 50 showing an initial focus position of the plurality of focus spots 26 within the liquid-assist medium 60 and adjacent the interface 110, according to an example machining process. As such, the optical system 40 is configured such that the plurality of focus spots 26 initially reside within the liquid-assist medium 60. After placement in the liquid-assist medium, the plurality of focus spots 26 are subsequently moved forward to be at or near an interface 110 defined by the back surface 104 (hereinafter, working surface 104) and the liquid-assist medium 60, e.g., in the liquid-assist medium within ˜10 μm of the interface 100. For example, the movable precision x-y-z stage 30 can be used to move the substrate 100 towards the image plane 28 (see FIGS. 1A-1B). The substrate 100 can be moved along the optical axis 12 so as to change the relative positioning of the plurality of focus spots 26 relative to the working surface 104. Particularly, the plurality of focus spots 26 are moved in a direction (the negative z-direction) parallel to the optical axis 12 to effectuate modification of the substrate 100 at different depths from the working surface 104.

As described herein, the optical system 40 is configured such that each of the plurality of focus spots 26 has sufficient intensity to alter the structure of the material that makes up the body 101 of the substrate to modify and structurally weaken the material. That is, each of the plurality of focus spots 26 is capable of independently modifying the dielectric material of the substrate 100 along a separate modification path. The system 10 differs from certain existing systems to perform liquid-assisted micromachining in that the beam-splitter 42 is employed to generate the plurality of beamlets 24 prior to the pulsed laser beam 22 interacting with the substrate 100. Separating the pulsed laser beam 22 into the plurality of beamlets 24 facilitates simultaneously modifying different portions of the material of the substrate 100 in the process of forming a single feature in the substrate 100. That is, separating the pulsed laser beam 22 into the plurality of beamlets 24 and forming the plurality of focus spots 26 allows different portions of a continuous volume of the material of the substrate 100 to be modified simultaneously in parallel with one another to increase the micromachining rate.

Separating the pulsed laser beam 22 into the plurality of beamlets 24 facilitates generating features in the substrate 100 with greater efficiency than in existing processes where only a single focal spot is used to modify the material in the process of forming a feature in the substrate 100. Such existing processes typically rely on steering optics, such as Galvanometric scanners, to steer the laser beam and determine a path over which the single focal spot modifies the material. While certain scanners can obtain beam steering speeds of several meters per second, such speeds are not obtainable when forming relatively small features (e.g., having diameters less than 500 μm or even 100 μm) due to the high acceleration/deceleration required. Delayed control responses associated with existing steering optics can also lead to ineffective feature formation. The system 10 described herein achieves feature formation at high rates by parallel processing the same area of the substrate 100 with multiple beamlets to form a single feature therein. As a result, the propagation direction of each beamlet 24 needs to be manipulated at a much lower rate to achieve the same effective rate of feature formation, as compared with existing techniques without beam-splitting. Since existing pulsed laser beam sources may have several times the power output required for multi-photon absorption for various dielectric materials, the splitting also enables a superior utilization of laser beam power.

To facilitate the plurality of focus spots modifying the substrate 100 in parallel with one another, the optical system 40 is configured to manipulate propagation directions of the plurality of beamlets 24 so that the beamlets move in a movement pattern such that the plurality of focus spats do not overlap one another in space at any points in time when the substrate 100 is being modified. To illustrate, FIG. 2B schematically depicts the substrate 100 being modified by the first focus spot 26a and the second focus spot 26b simultaneously. The image plane 28 of the focusing optics 44 has been moved to be within the body 101. As shown, within the image plane 28, the first and second focus spots 26a, 26b do not overlap one another (i.e., are completely offset from one another so that no single portion of the body 101 is modified by both the first and second focus spots 26a, 26b simultaneously). Generally, the propagation direction of the plurality of beamlets 24 are manipulated so that each of the plurality of beamlets 24 simultaneously moves in one or more directions perpendicular to the working surface 104 and first surface 102 and/or the image plane 28. As such, in the depicted example, as the plurality of focus spots 26 are moved in the image plane 28, the image plane 28 is moved relative to the working surface 104 along the optical axis 12 so that each of the plurality of focus spots 26 is moved through the substrate 100 toward the first surface 102 such that each focus spot independently modifies the transparent dielectric material along a separate modification path.

The first focus spot 26a is depicted to modify the body 101 along a first modification path 27a and the second focus spot 26b is depicted to modify the body 101 along a second modification path 27b. The first and second modification paths 27a, 27b may have various shapes. In embodiments, the first and second modification paths 27a, 27b have the same shape. For example, the first and second modification paths 27a, 27b may each have a helical shape described in U.S. Pat. No. 11,247,932 B2 (e.g., each helical motion path can have a pitch ranging from 0.1 μm to 30 μm and a diameter that is less than or equal to 500 μm). In other embodiments, the first and second modification paths may differ from one another. The lateral dimensions of the modification paths can be controlled through motion of the plurality of focus spots 26 over the motion path MP in the x and y directions and the depth of the feature can be controlled by movement of the focus spot over the motion path in the z direction. The first and second modification paths 27a, 27b may be consistent throughout the depth of the body 101 (to generate features having constant diameter in, for example, the x-y plane), or change as the image plane 28 is moved through the body 101 (e.g., to generate features having non-constant dimensions or varying cross-sectional shape).

In one embodiment, formation of the plurality of modification paths 27 includes ablation of the material that makes up the body 101 of the substrate 100. As material is removed from the working surface 104, the liquid-assist medium 60 from the cuvette 50 flows to occupy the evacuated space to maintain a wetted surface for heat removal and further micromachining. Micromachining at different depths relative to the working surface 104 is achieved by moving the plurality of focus spots 26 (either through variation in the optical system 40 or relative motion of the laser and working surface) in the direction from the working surface 104 toward the first surface 102 of the substrate 100 in a plurality of modification paths 27. The modification paths 27 can be formed in the body 101 of the substrate 100 having depths varying from a partial thickness of the substrate to the full thickness of the substrate. In an example, the size (diameter) of the plurality of focus spots 26 is selected to facilitate the flow of the liquid-assist medium 60 through micromachined regions of the body 101.

FIG. 2C is a close-up view of the irradiated portion of the substrate 100 upon completion of the first and second modification paths 27a, 27b. In the depicted example, the first and second modification paths 27a, 27b extend from the working surface 104 to the first surface 102. Just the liquid-assist medium 60 of the cuvette is shown in FIG. 2C for case of illustration. Localized micromachining occurs in the vicinity of each position of each one of the first and second focus spots 26a, 26b within the body 101 of the substrate 100 along the first and second modification paths 27a, 27b. Each of the first and second modification paths 27a, 27b is depicted to include a plurality of micromachined regions 123 where the material of the substrate 100 has been modified. The micromachined regions 123 can be in the form of microcavities created by ablation and that form contiguous channels within the material that makes up the body 101 of the substrate 100. The micromachined regions 123 of the first and second modification paths 27a, 27b are encompassed within a continuous volume 29 of the material of the body 101. The micromachined regions 123 constitute regions of mechanical weakness which represent a trajectory for separation of the continuous volume 29 from the rest of the body 101 of the substrate 100. As shown in FIG. 2D, the continuous volume 29 can be removed from the rest of the body 101 to form a feature 150 having an interior surface 153 in the substrate 100. Typically, the continuous volume 29 spontaneously separates during processing to form the feature 150. Compressed air or washing in a stream of liquid-assist medium can optionally be used to facilitate removal of continuous volume 29 after processing.

Thus, with reference again also to FIGS. 1A and 1B, in an example of the operation of the system 10, the plurality of beamlets 24 passes through the body 101 of the substrate 100 so that the plurality of focus spots 26 resides in the liquid-assist medium 60 adjacent the interface 110 as shown in FIG. 2A. The micromachining occurs in a −z direction, i.e., counter to the +2 direction of the pulsed laser beam 22. That is, relative to the initial direction of propagation of the pulsed laser beam, the working surface 104 is closer to the pulsed laser beam source 20 than the initial position of the plurality of focus spots 26, and micromachining occurs by moving the focus spots over modification paths that have a component in the −z direction, which is toward the working surface 104 and the pulsed laser beam source 20.

As noted above, a plurality of modification paths 27 can be used to form a given single feature 150, and multiple features can be used to form an array of features. Features 150 other than holes can be similarly fabricated by suitably controlling the movement patterns of the plurality of beamlets 24 relative to the body 101 of the substrate 100 to change the overall shape of the continuous volume 29 encompassing the plurality of modification paths 27. Cross-sectional shapes of features 150 include circular, elliptical, round, square, and rectangular. Example features 150 can extend through the thickness 106 of the substrate 100 in its entirety to form through holes such as shown in FIG. 2D, or alternatively extend through a fraction of the thickness of the substrate. Generally, the features 150 can include grooves, channels, recesses, holes and slots having arbitrary cross-sectional shapes.

A preferred mechanism of material removal includes laser ablation and material removal through acoustic shock generated by cavitating bubbles. To avoid heating and melting of the substrate 100, linear absorption of the plurality of beamlets 24 by the substrate is minimized and ablation is instead effected by non-linear optical absorption. Non-linear optical absorption occurs in transparent materials when the intensity of the laser exceeds an intensity threshold. The intensity of the pulsed laser beam 22 can be controlled by adjusting the power of the laser source and/or the focusing the laser beam by the optical system 40. Non-linear optical absorption is a multiphoton absorption process that has an absorption coefficient that increases with increasing intensity. The high intensity and tight focusing of the plurality of beamlets 24 leads to strong non-linear absorption in a highly localized region of the material allowing for dimensional control of features 150 with precision/accuracy of 0.5 microns or smaller. The conditions can be controlled to provide absorbed energy that is sufficiently high to directly ablate a portion of the substrate 100 without proceeding through a melting transition. Thermal effects during laser micromachining are further minimized when using pulsed lasers with laser pulses 22P having a pulse duration less than about 100 ps, or less than about 50 ps, or less than about 25 ps. Ablation through non-linear absorption provides a mechanism for removing material from the substrate 100 and enables the formation of a select modification patterning or formation of fine features in the material that makes up the body 101 of the substrate 100.

As material is dry-ablated from the substrate 100, debris can form and accumulate on the first surface 102 or on the interior surface 153. When forming features 150 in the form of through holes, for example, debris accumulates within the hole. The debris is difficult to remove and can interfere with the ablation process by, for example, scattering the laser beam and preventing attainment of the localized intensity needed for non-linear absorption. To aid removal of debris, liquid-based laser micromachining can be performed as described above. As ablation occurs, the liquid-assist medium 60 displaces debris from the working surface 104 to prevent accumulation of the debris and to provide holes and other features free of clogs. The liquid-assist medium also removes heat from the working surface 104, as noted above. In an example, the liquid-assist medium assists in pushing the continuous volume 29 out of the body 101 of the substrate.

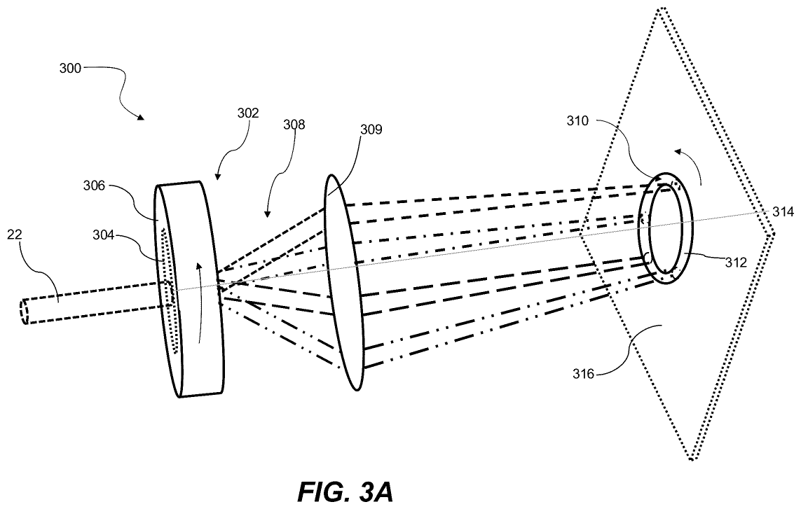

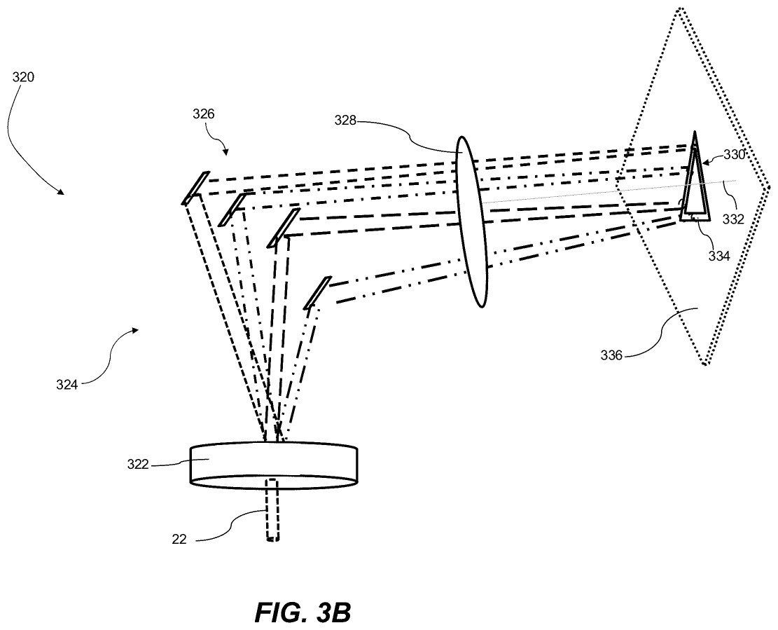

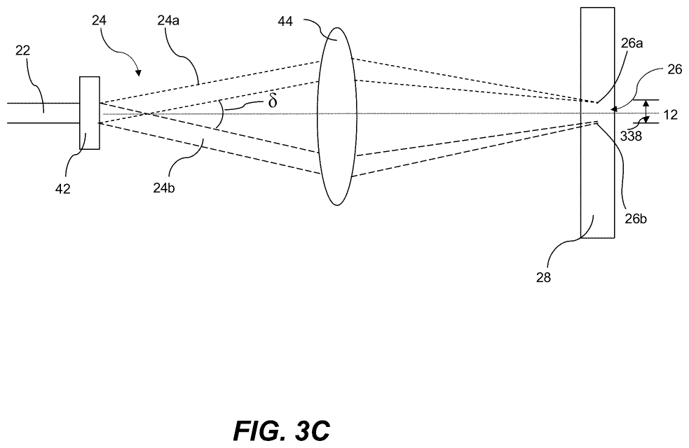

A variety of ways of manipulating the propagation directions of the plurality of beamlets 24 to provide movement patterns for the plurality of focus spots 26 are contemplated. For example, FIG. 3A depicts an optical system 300 that may be used in place of the optical system 40 in the system 10 described herein with respect to FIGS. 1A-2D. Beam conditioning optics are omitted from the optical system 300 for the purposes of discussion. The optical system 300 includes a rotating beam-splitter 302. The rotating beam-splitter 302 includes a beam-splitter 304 that is mounted on a rotating support 306. The beam-splitter 304 may be any of the optical elements described herein with respect to the beam-splitter 42 discussed above. The rotating support 306 comprises a support structure attached to the beam-splitter 304 (e.g., at an external surface thereof) and configured to rotate the beam-splitter 304 in a plane perpendicular to an optical axis 314 of the optical system 300 (e.g., via an actuator). The beam-splitter 304 is configured to generate a plurality of beamlets 308 that may be uniformly distributed about the optical axis 314. Rotation of the beam-splitter 304 causes the plurality of beamlets 308 to rotate about the optical axis 314 in unison with one another at a speed determined by the rotation rate of the beam-splitter 304. Focusing of the plurality of beamlets 308 with focusing optics 309 results in a plurality of focus spots 310 that move along a circular path 312 in an image plane 316 of the focusing optics 309. Movement of the image plane 316 relative to the substrate 100 (e.g., via the x-y-z stage 30 described herein) can result in each of the plurality of beamlets 308 modifying the substrate 100 along a separate helical modification path so that the continuous volume 29 (see FIG. 1C) is cylindrical to form a hole of uniform diameter in the substrate 100.

FIG. 3B depicts an optical system 320 that may be used in place of the optical system 40 in the system described herein with respect to FIGS. 1A-2D. The optical system 320 includes a beam-splitter 322 that may remain stationary and be configured to separate the pulsed laser beam into a plurality of beamlets 324. Downstream of the beam-splitter 322, the optical system 320 includes a plurality of scanning elements 326 that are configured to independently manipulate a propagation direction of each one of the plurality of beamlets 324. The plurality of scanning elements 326 can be any suitable optical element configured to manipulate the propagation direction of the plurality of beamlets 324. For example, each scanning element can be a galvanometric scanner or a microelectromechanical system (MEMS) mirror. In embodiments, the plurality of scanning elements 326 are positioned such that a single one of the plurality of beamlets 324 is incident on each one of the plurality of scanning elements 326. Manipulating the orientation of each scanning element thus enables independent control of the propagation direction of each individual beamlet. Downstream of the plurality of scanning elements 326 is focusing optics 328 configured to generate a plurality of focus spots 330 in an image plane 336. Manipulation of the plurality of scanning elements 326 enables the plurality of focus spots 330 to be provided in any desired arrangement within the image plane 336 to facilitate creating features having an arbitrary shape. As depicted, the plurality of focus spots 330 are moved in a triangular path 334 about the optical axis 332 within the image plane 336. Provision of the plurality of scanning elements 326 enables manipulation of the movement path in the image plane 336 as the position of the image plane 336 is altered to form features that vary in cross-sectional shape as a function of depth within the substrate 100.

Referring now to FIG. 3C, the general operation of the beam-splitter 42 (or the beam-splitters 304 and 322 described with respect to FIGS. 3A and 3B) and focusing optics 44 (or the focusing optics 309 and 328 described with respect to FIGS. 3A and 3B) will now be described. In embodiments, the beam-splitter 42 is configured to generate the plurality of beamlets 24 such that the beamlets are deflected at a deflection angle δ relative to one another in a direction perpendicular to the optical axis 12. Certain beam-splitters may have a relatively small deflection angle δ of less than 1°. For example, certain Wollaston prisms, shallow roof prisms, or inverted pyramid prisms may have a deflection angle δ of approximately 0.34°. The properties (e.g., focal length) and positioning of the focusing optics 44 may be set based on the deflection angle δ, which determines an angle of incidence Θᵢₙ (not depicted) of the plurality of beamlets 24 on the focusing optics 44. In embodiments, the focusing optics 44 and beam-splitter 42 may be selected to provide a focus spot separation distance 338 (center-to-center) in the image plane 28 that is less than or equal to a desired size (e.g., diameter) of the feature being formed in the substrate 100. The depicted focus spot separation distance 338 is a minimum linear distance between a geometric center of each focus spot in a pair of focus spots. In an example, a beam-splitter 42 with a 0.34° deflection angle used in conjunction a focal lens with a 100 mm focal distance is predicted to lead to a focal spot separation distance of about 0.55 mm in the image plane 28, which is the upper side of feature sizes created using liquid-assisted micromachining.

Generally, the beam-splitter 42 and focusing optics 44 can be engineered to impart small-angle deflections on the pulsed laser beam 22 and enable wide range of focus spot separation distances. The control of the focus spot separation can be designed through use of a transfer matrix for a prism and lens. To illustrate, if a case of a simple 1×2 beam-splitter (comprised of a thin roof prism) and an ideal lens system is considered, the separation of the beamlets (2Δx) at the image plane (corresponding to the focus spot separation distance 338 depicted in FIG. 3C) can be predicted using a ray transfer matrix of the system. More particularly, the deflection angle δ of the beam-slitter 42 may result in the beamlets being separated by a distance xᵢₙ from the optical axis 12 when incident on the focusing optics 44 at an angle of incidence Θᵢₙ. In such a case, the separation of the plurality focus spots 26 (e.g., a pair thereof on opposing sides of the optical axis 12) can be predicted as follows:

$$2 Δ x = 2 * {x}_{out} = \vert 2 * [ A * {x}_{i n} + B * {θ}_{i n} ] \vert , \qquad ( 1 )$$

where A and B are transfer matrix elements of the focusing optics 44. The relationship between Θᵢₙ, xᵢₙ (at incidence on the focusing optics 44) to Θₒᵤₜ, xₒᵤₜ (upon emission from focusing optics 44) can be expressed as follows:

$$[ \begin{matrix}{x}_{i n} \\ {Θ}_{i n}\end{matrix} ] * ( \begin{matrix}A & B \\ C & D\end{matrix} ) = [ \begin{matrix}{x}_{out} \\ {Θ}_{out}\end{matrix} ] . \qquad ( 2 )$$

A,B, C, and D are the elements of the transfer matrix of the focusing optics 44 between the conditioning optics 46 and the back focal plane (the image plane 28). Since, in this case, the deflection angle from a small-angle wedge prism would be the same as the incident angle launched into the focusing optics 44, we can readily define the input angle as θᵢₙ=δ=(nₚᵣᵢₛₘ−1)*α, where nₚᵣᵢₛₘ and α are the wedge prism index of refraction and prism angle, respectively. Additionally, if it is assumed that rays are launched into the optical system 40 along the optic axis (xᵢₙ=0), the previous equation for beamlet separation is further simplified as |2*B*δ|. Hence the wedge prism angle or Wollaston prism deflection angle and/or the focal lengths can be readily selected to create target beamlet separation.

In an example, a doublet lens is used for the focusing optics 44. The doublet lens had a first lens formed of N-BK7 with a front radius of 31.8 mm (convex towards the laser beam source 20 indicated by positive), a back radius of −47.097, and a thickness of 17 mm on the optical axis 12. The first lens had an aperture of 25.4 mm in both the x- and y directions. The doublet lens included a second lens formed of SFS and was separated from the first lens by a 0.1 mm air gap along the optical axis 12. The second lens had a front radius of −47.097 mm, a back radius of −128.83 mm, and a thickness of 4 mm on the optical axis. The second lens had an aperture of 25.4 mm in both the x- and y directions. Such a lens possesses the following transfer matrix:

$$( \begin{matrix}A & B \\ C & D\end{matrix} ) = ( \begin{matrix}3.673 e - 40 & 100.7 \\ - 0.009927 & 0.965\end{matrix} )$$

When this lens is used in conjunction with a pair of wedge prisms (α=0.25 deg) as the beam-splitter 42, after rays pass through the wedge prisms, beams will deflect at an angle of 8=0.125 deg. The resulting separation of the deflected beamlets at the image plane is 0.44 mm, which would enable 0.44 mm apertures or vias in transparent dielectric materials. This example demonstrates how the construction of the beam-splitter 42 and focusing optics 44 may be selected to provide a particular separation of the focus spots. One benefit of the optical system 320 depicted in FIG. 3B is that the parameters Θᵢₙ, xᵢₙ for each individual beamlet are adjustable, rendering the beam separation adjustable without changing the focusing optics 44. Non-uniform separation of the focus spots is achievable to create features having unique shapes.

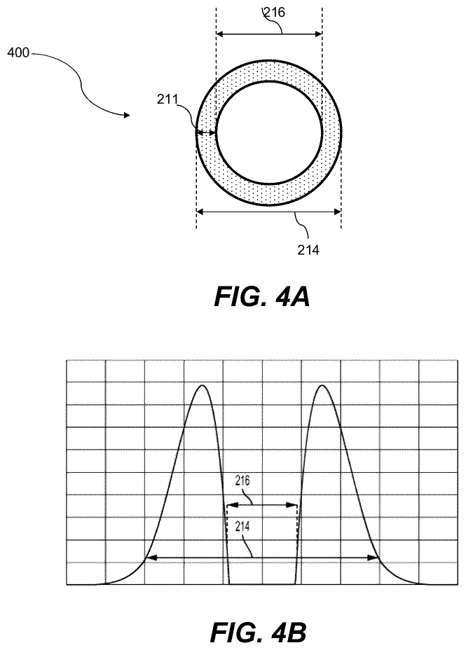

A consideration when introducing the beam-splitter 42 into the optical path of the pulsed laser beam 22 is distortion. Distortion when rays of different laser beams propagate through various beam-splitters (Wollaston prism, roof prism, inverted pyramid) was simulated using Fred Optical Engineering Software, assuming the laser beam was focused using the doublet lens discussed in the preceding example. Two different power profiles for the pulsed laser beam 22 were simulated: a Gaussian profile and an annular profile. An example annular profile 400 is depicted in FIGS. 4A and 4B. As shown, the annular profile 400 includes an inner diameter 216, an outer diameter 214, and an annular thickness 211. According to embodiments, the inner diameter 216 is defined as twice the distance (i.e., a radius) where 86% of the beam energy is outside of that distance from the center of the beam (i.e. from the center of the annular profile 440). Similarly, the outer diameter 214 is defined as twice the distance (i.e., a radius) where 86% of the beam energy is inside of that distance from the beam center. Further, the annular thickness 211 is the difference between the outer diameter 214 and the inner diameter 216. When an axicon is used to form the annular profile 400, the annular thickness 211 may correspond to an initial radius of the input laser beam (beyond the depth of focus of the axicon). The outer diameter 214 at the beam splitter 44 is proportional to a distance along the optical axis between the conditioning optics 46 and the beam splitter 42. The arrangement of optical elements in the system 10 can determine the size of the annular beam profile 211.

According to embodiments, the outer diameter 214 may be from about 0.1 μm to 10,000 μm, such as from about 0.1 μm to about 1,000 μm, about 0.1 μm to about 500 μm, about 0.1 μm to 100 μm, from about 0.1 μm to 50 μm, or from about 0.1 μm to 10 μm. In embodiments, the inner diameter 216 may be from about 5% to about 95% of the outer diameter 214, such as from about 10% to about 50%, from about 20% to about 45%, or from about 30% to about 40% of the outer diameter 214. Further, the annular thickness 211 may be from about 0.04 mm to about 1000 μm for example, about 0.01 μm to 100 μm, or about .01 μm to 10 μm.

Results of the simulations conducted are provided in the Table 1 below. The provided dimensions are focus spot dimensions assuming the rays were focused using the previously described doublet lens.

TABLE 1

| | Beam | | FWHMₓ | FWHM_{y} | DOF, |
|---|---|---|---|---|---|
| Case | Profile | Beam-Splitter | (μm) | (μm) | FWHM_{z} (μm) |
| 1 | Gaussian | N/A | 8.6 | 8.6 | 364 |
| 2 | Annular | N/A | 6.4 | 6.4 | 292 |
| 3 | Gaussian | Wollaston | 8.7 | 8.7 | 363 |
| 4 | Annular | Wollaston | 5.8 | 5.8 | 287 |
| 5 | Gaussian | Roof Prism | 8.7 | 15.7 | 374 |
| 6 | Annular | Roof Prism | 5.8 | 12.8 | 300 |
| 7 | Gaussian | Inverted Pyramid | 14.3 | 15.4 | 342 |
| 8 | Annular | Inverted Pyramid | 9.8 | 19 | 310 |

As shown, in all cases, the annular beam profile allows for tighter focusing in at least one of the x or y-directions than the Gaussian power profile. It is believed that this difference is because Gaussian beams become distorted by the apex of refractive beam-splitters. Annular beams, in contrast, are not affected to the same extent due to the lack of a central peak along the optical axis. It is believed that the annular power profile is advantageous by allowing for tighter focusing in at least one direction to facilitate precise modifications of the dielectric material.

The features 150 formed via the methods described herein can generally be characterized as having interior surfaces 153 (see FIG. 2D) that are relatively smooth. In embodiments, the interior surfaces 153 generated via the methods described herein can have an RMS (root-mean-square) roughness and RMS waviness of less than 0.5 μm. Such low surface roughness can lead to dimensional uniformity. When forming features 150 having a cross-section with a linear dimension, the variability in the linear dimension attributable to surface roughness is less than 1.0 μm, or less than 0.8 μm, or less than 0.6 μm, or less than 0.4 μm, or in the range from 0.2 μm-1.0 μm, or in the range from 0.2 μm-0.8 μm, or in the range from 0.2 μm-0.6 μm, or in the range from 0.2 μm-0.5 μm. As used herein, variability in linear dimension refers to the difference between the maximum and minimum value of the linear dimension. It should be noted that other process limitations (e.g. stability of the laser, precision of positioning of the laser) may contribute to variability in linear dimensions independent of the contribution from surface roughness. Linear dimensions include length, width, height, depth, and diameter.

When forming circular features 150 (e.g. circular holes), for example, the variability in diameter attributable to RMS surface roughness is less than 1.0 μm, or less than 0.8 μm, or less than 0.6 μm, or less than 0.5 μm, or less than 0.4 μm, or in the range from 0.2 μm-1.0 μm, or in the range from 0.2 μm-0.8 μm, or in the range from 0.2 μm-0.6 μm, or in the range from 0.2 μm-0.5 μm. As used herein, variability in diameter refers to the difference between the maximum diameter and minimum diameter. In certain embodiments, the diameter varies no more than 1% from an average value throughout an entirety of a length of the feature.

In one aspect, features 150 having a high aspect ratio are formed by liquid-assisted laser micromachining using the system 10. For a feature 150 in the form of a hole with a circular cross-section, the aspect ratio corresponds to the ratio of the depth of the hole (a dimension normal to the incident surface) to the diameter of the hole (a dimension orthogonal to the depth of the hole). For a hole with a square cross-section, the aspect ratio corresponds to the ratio of the depth of the hole (a dimension normal to the incident surface) to the side length of the hole (a dimension orthogonal to the depth of the hole). For a hole with a rectangular cross-section, the aspect ratio corresponds to the ratio of the depth of the hole (a dimension normal to the incident surface) to the smaller of the side length or side width of the hole (a dimension orthogonal to the depth of the hole). For a hole with an elliptical cross-section, the aspect ratio corresponds to the ratio of the depth of the hole (a dimension normal to the incident surface) to the length of the minor axis of the hole (a dimension orthogonal to the depth of the hole). In some embodiments, the aspect ratio is greater than 2:1, or greater than 4:1, or greater than or equal to 5:1, or greater than 6:1, or greater than 8:1, or greater than 10:1, or in the range from 2:1-20:1, or in the range from 3:1-15:1, or in the range from 4:1-10:1.

The present disclosure encompasses substrates 100 having features with roughness, variability in linear dimension, and/or aspect ratio described herein. Substrate products formed by liquid-assisted laser micromachining of substrates 100 using a liquid-assist medium 60 in system 10 are within the scope of the present disclosure. In one aspect, the feature 150 extends through a thickness 106 of the substrate 100 and the product is in the form of an optical fiber support device that can support an optical fiber inserted in the feature, as described below.

### Optical Fiber Components

As discussed above, embodiments of the disclosure are directed to methods of forming optical fiber components by processing the substrate 100 using system 10. An aspect of the disclosure includes the optical components themselves as products formed by the liquid-based micromachining methods (processes) disclosed herein that are carried out using the system 10. Examples of such optical fiber components are set forth below.

In an embodiment, the substrate 100 can be processed as described above to form one or more features 150 that are through-holes configured to facilitate efficient guiding of one or more optical fibers. In this embodiment, the substrate 100 constitutes an optical fiber guide member or “guide member,” and such through-holes may be referred to as “fiber through-holes.”

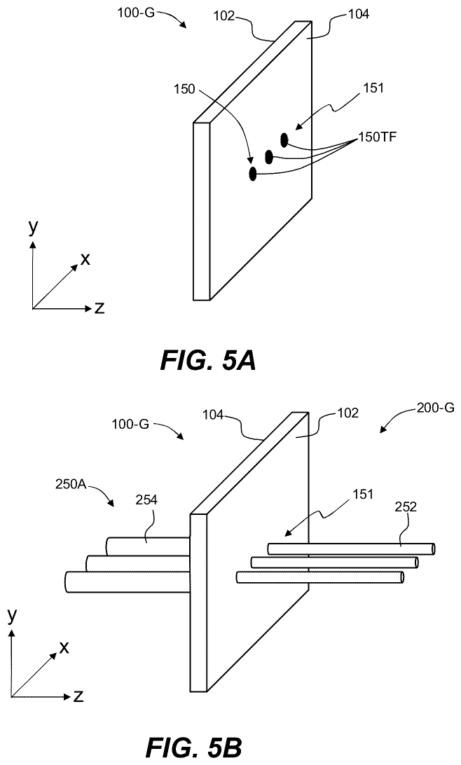

FIG. 5A is a back elevated view of an example guide member 100-G that includes an array 151 of features 150 in the form of three fiber through-holes 150TF arranged in a row along the x-direction. FIG. 5B is similar to FIG. 5A and shows an example optical fiber guiding device (“guiding device”) 200G that comprises the guide member 100-G of FIG. 5A and an array (“fiber array”) 251 of three optical fibers (“fibers”) 250 that respectively extend through the three fiber through-holes 150TF. Each fiber 250 includes a bare section 252 (which can be bare glass or include a non-glass coating) and a buffered section 254 defined by protective jacket (e.g., a polymer jacket) 256. In one example, the fiber through-holes 150TF are sized to closely accommodate the buffered section 254 while in another example the through-holes are sized to closely accommodate the bare section 252. The fiber array 251 can comprise multiple rows and/or columns and generally can have a variety of configurations and number of fibers 250 useful for optical fiber applications.

### Optical Fiber Interconnection Members and Devices

In an embodiment, the substrate 100 can be processed as described above to form an array 151 of features 150 that are fiber through-holes 150TF configured to facilitate efficient optical coupling between two optical fibers 250. In this embodiment, the substrate 100 constitutes an optical fiber interconnection member or “interconnect member,” and is referred to hereinafter as 100-I.

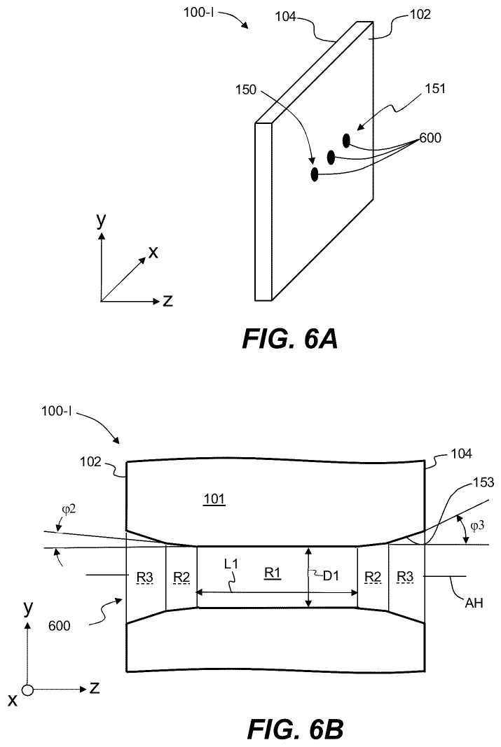

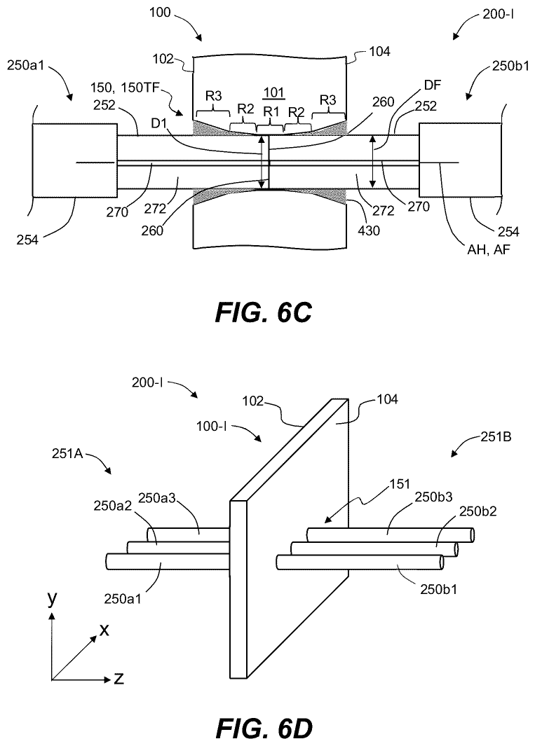

FIG. 6A is a back elevated view of an example interconnect member 100-I that includes an array 151 of three features 150 in the form of tapered fiber through-holes 600 arranged in a row along the x-direction and configured to facilitate optical coupling between two fibers 250.

FIG. 6B is a close-up y-z cross-sectional view of an example tapered fiber through-holes 600 of the example interconnect member 100-1, wherein each fiber through-hole is configured to facilitate optical coupling of two fibers 250. The tapered fiber through-hole 600 includes three regions denoted as R1, R2 and R3 and has a central hole axis AH. The region R1 is a central region centered substantially midway between the front and back surfaces 102 and 104 and having a length L1 and the smallest size (diameter D1). The region R1 is formed so that the two fibers 250 to be optically coupled closely fit within this region to ensure end-to-end alignment of the two fibers for low optical loss. The size (diameter D1) of the central region R1 is tightly controlled, e.g., to within 1 micron or less of the target diameter and only slightly larger than a diameter DF of an optical fiber. In an example, the length L1 of region R1 is about 10·D1 to ensure that optical fibers are held within the fiber through-hole 150TF, as shown and explained below. Note that FIG. 6B and subsequent related Figures are not to scale for case of illustration.

The second region R2 sandwiches the central region R1 and is slightly larger than the central region R1 (e.g., 1 micron larger) but still small enough to maintain angular alignment of the two fibers 250 to be optically coupled. The second region R2 has an axial length L2. The slightly larger size (diameter) of second region R2 allows for the interior surface 153 of this region to be rougher than that of the central region R1. The second region R2 preferably has an outward taper or flare, i.e., a taper wherein the radius of the second region R2 increases in the direction away from the central region R1 to define a taper angle φ2. The length L2 is shorter than L1 and is a transition region between the central region R1 and the outermost region R3.

The third region R3 sandwiches the second region R2 and has an axial length L3 an outward taper with a taper angle φ3>φ2 so that the size of the fiber through-hole 150TF at the front and back surfaces 102 and 104 of the interconnect member 100-I is considerably larger than the fiber diameter, e.g., 10 microns to 25 microns larger. The tapered configuration of the third region R3 acts as a funnel to guide the given fiber into fiber through-hole 150TF. The fiber through-hole 150TF thus constitutes a double-ended tapered fiber through-hole. The length L3 need only be long enough to facilitate inserting a fiber into the fiber through-hole 150TP.

FIG. 6C is similar to FIG. 6B but showing two fibers 250, denoted 250a1 and 250b1, which are inserted into the fiber through-hole 150TF from the front surface 102 and the back surface 104, respectively, of the interconnect member 100-I. Each fiber 250 has a fiber axis AF, an end face 260, a core 270 and a cladding 272. The fiber end faces 260 are confronting in the central region R1 of the fiber through-hole 150TF and in an example are in contact. The fiber axes AF are also co-axial with the hole axis AH. A securing material 430 such as a UV-activated adhesive can be used to secure the fibers 250 within the fiber through-hole 150TF. In an example, the securing material has a relatively low viscosity so that it flows into and fills the gap between the fibers 250 and the interior surface 153. The scale of FIG. 6C is axially compressed relative to FIG. 6B for ease of illustration. As described above, the tapered configuration of the fiber through-hole 150TF with the close-fitting central region R1 allows for both easy insertion of the fibers 250a1 and 250b1 into the fiber through-hole from opposite sides while also providing for close optical alignment of the respective cores 270 of the two fibers.

FIG. 6D is similar to FIG. 6A and shows an example optical fiber interconnection device 2001 that includes a first array 251A of optical fibers 250 (250a1, 250a2, 250a3 optically coupled to a second array 251B of optical fibers 250 (250b1, 250b2, 250b3) using the three tapered fiber through-holes 600 of the interconnect member 100-I. In an example, each tapered fiber through-hole 600 is configured as shown in FIG. 6B. Other configurations of the fiber through-holes, including cylindrical, can also be employed.

It should be understood that the components depicted in FIGS. 5A-6D are only exemplary and that the systems and methods described herein can be used to fabricate a variety of different components with different surface features. For example, any of the components described in U.S. Pre-Grant Publication No. 2019/0062196 A1 can be fabricated via the system 10 described herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method of processing a substrate having a substrate body made of a transparent dielectric material and having a first surface and a working surface opposite the first surface, comprising:
disposing the working surface in contact with a liquid-assist medium;
generating a pulsed laser beam;
separating the pulsed laser beam into a plurality of beamlets;
forming a plurality of focus spots from the plurality of beamlets, wherein each of the focus spots has a fluence above a threshold to induce multiphoton absorption in the transparent dielectric material, wherein the plurality of focus spots each have an initial position in the liquid-assist medium;
altering a positioning of the plurality of focus spots in a first direction perpendicular to an optical axis;
while the positioning of the plurality of focus spots is altered in the first direction, moving the focus spots relative to the working surface in a second direction parallel to the optical axis so that each of the plurality of focus spots is moved through the substrate toward the first surface, wherein, as each of the plurality of focus spots is moved through the substrate, each focus spot independently modifies the transparent dielectric material along a separate modification path; and
removing a continuous volume of the transparent dielectric material containing each of the separate modification paths to form a feature in the substrate.

2. The method according to claim 1, wherein the threshold is 40 J/cm².

3. The method according to claim 1, wherein the pulsed laser beam comprises:
a pulse duration that is greater than or equal to 1 picosecond and less than or equal to 50 picoseconds, and
a pulse repetition rate that greater than or equal to 1 kHz and less than or equal to 200 kHz.

4. The method according to claim 1, wherein the feature comprises an aspect ratio, calculated as t/d, with t being a depth of the feature measured from the working surface in a direction perpendicular to the working surface and d being an average diameter of the feature measured in a direction perpendicular to that in which the depth is measured, that is greater than or equal to 5.

5. The method according to claim 4, wherein d is less than or equal to 0.5 mm.

6. The method according to claim 1, wherein each of the focus spots comprises a spot size that is greater than or equal to 2 μm and less than or equal to 20 μm.

7. The method according to claim 1, wherein, prior to separating the pulsed laser beam into the plurality of beamlets, the pulsed laser beam comprises an annular power profile.

8. The method according to claim 1, wherein, prior to separating the pulsed laser beam into a plurality of beamlets, the pulsed laser beam is circularly polarized.

9. The method according to claim 1, wherein the separating the pulsed laser beam into the plurality of beamlets comprises transmitting the pulsed laser beam through a beam-splitter, wherein the beam-splitter comprises one of a Wollaston prism, a roof prism, and an inverted pyramid prism.

10. The method according to claim 9, wherein the altering the positioning of the plurality of focus spots in the first direction perpendicular to the optical axis comprises rotating the beam-splitter so that each of the plurality of focus spots rotates around the optical axis in conjunction with one another.

11. The method according to claim 9, wherein the altering the positioning of the plurality of focus spots in the first direction perpendicular to the optical axis comprises independently manipulating a propagation direction of each beamlet using a separate scanning element.

12. The method according to claim 1, wherein forming the plurality of focus spots from the plurality of beamlets comprises transmitting the plurality of beamlets through a focusing lens so as to form the plurality of focus spots in an image plane of the focusing lens.

13. The method according to claim 12, wherein centers of adjacent ones of the plurality of focus spots in the image plane are separated from one another by less than or equal to 0.5 mm.

14. The method according to claim 13, wherein the focus spots do not overlap one another in the image plane.

15. The method according to claim 1, wherein the feature comprises at least one of: a hole, a groove, a channel, a slot and a recess.

16. The method according to claim 15, wherein the feature comprises side walls extending substantially perpendicular to the working surface, the side walls comprising root-mean square (rms) roughness and rms waviness that is less than or equal to 0.5 μm.

17. The method according to claim 1, wherein the feature is a substantially cylindrical-shaped hole with a diameter that varies no more than 1% from an average value throughout an entirety of a length thereof.

18. The method according to claim 1, wherein the liquid-assist medium comprises water and optionally includes a surfactant.

19. A method of processing a substrate having a substrate body made of a transparent dielectric material and having a first surface and a working surface opposite the first surface, comprising:
disposing the working surface in contact with a liquid-assist medium;
generating a pulsed laser beam,
separating the pulsed laser beam into a plurality of beamlets and transmitting the plurality of beamlets through a focusing lens to form a plurality of non-overlapping focus spots in an image plane of the focusing lens located initially in the liquid-assist medium;
moving the plurality of non-overlapping focus spots in the image plane relative to an optical axis of the focusing lens;
while the non-overlapping focus spots are moved in the image plane, moving the image plane relative to the working surface along the optical axis so that each of the plurality of non-overlapping focus spots is moved through the substrate toward the first surface such that each focus spot independently modifies the transparent dielectric material along a modification path; and
removing a continuous volume of the transparent dielectric material containing each of the modification paths to form a feature in the substrate.

20. The method according to claim 19, wherein each of the plurality of non-overlapping focus spots independently induces a non-linear absorption in the substrate to modify the transparent dielectric material.
